(19) United States
(12) Patent Application Publication
(10) Pub. No.: US 2014/0333254 A1
(43) Pub. Date: Nov. 13, 2014

(54) WIRELESS CHARGING DEVICE

(71) Applicant: MERRY ELECTRONICS (SHENZHEN) CO., LTD., Shenzhen (CN)

(72) Inventor: Chia-Wen TENG, Taichung City (TW)

(73) Assignee: MERRY ELECTRONICS (SHENZHEN) CO., LTD., Shenzhen (CN)

(21) Appl. No.: 13/952,817

(22) Filed: Jul. 29, 2013

(30) Foreign Application Priority Data
May 13, 2013 (TW) 102208867

(51) Int. Cl. H02J 7/02

(52) U.S. Cl. CPC H02J 7/025
USPC 320/108

(57) ABSTRACT

A wireless charging device includes a transmitter unit containing a transmitter circuit, and a receiver unit detachably connects the transmitter unit and containing a receiver circuit. When the receiver circuit is kept within the induction range of the transmitter circuit, the receiver circuit can generate electricity by induction from the transmitter circuit. The induced electricity is transmitted via a transmission port to charge an electronic device without wireless charging function. The transmitter unit can also be used independently to charge an electronic device with wireless charging function. Thus, the wireless charging device has the advantages of ease of use and portability.

### BACKGROUND OF THE INVENTION

1. Field of the Invention

The present invention relates to wireless charging technology and more particularly, to a wireless charging device capable of providing electricity to electronic devices without wireless charging function and enables the electronic devices to be electrically charged. The wireless charging device is compatible with most electronic devices, enabling users to get rid of the inconvenience of carrying different transformers.

2. Description of the Related Art

Wireless charging products have the advantages of non-contact housing, and it allows greater flexibility in product design, especially in waterproof or dustproof electronic products However, due to safety considerations in the past, wireless charging technology is only used in low-power products. As technology advances, some electronic devices using high-capacity battery and must be charged with high power, such as smart phones, have equipped with wireless charging function and commercialized in the market. The current conversion efficiency of wireless charging is about 75%. By means of chips integration and decreasing the use of discrete chips, the product size and cost can be significantly reduced, and the conversion efficiency can be possibly increased up to 90%. For consumers, if the majority of electronic devices equip with wireless charging function, it not only can reduce energy consumption but also get rid of various kinds of transformers.

Unfortunately, most electronic devices in need of charging do not support wireless charging. The main reason is presumed for safety considerations because electronic devices supporting wireless charging need to prevent the heat accumulation problem caused by the coupling between surrounding metallic materials and the magnetic field of the transmitter coil. To solve these problems, US2011241615 discloses a design to install a transmitter circuit in a transformer for wireless charging, enabling the transformer to provide electricity to a notebook computer using the transformer and to charge an electronic device with wireless charging function. However, this patent is still restricted to a notebook computer using this design of transformer, not applicable to other electronic devices without wireless charging function.

### SUMMARY OF THE INVENTION

The present invention has been accomplished under the circumstances in view. It is the main object of the present invention to provide a wireless charging device, which is practical for charging an electronic device with wireless charging function as well as an electronic device without wireless charging function.

To achieve this and other objects of the present invention, a wireless charging device comprises a transmitter unit, which comprises at least one transmitter circuit disposed on a top thereof and electrically connected to a power source, a receiver unit, which is detachably mounted to a bottom of the transmitter unit and comprises a receiver circuit, and at least one transmission port mounted to the receiver unit and electrically connected to the receiver circuit for transmitting electricity. When the receiver unit is mounted to the bottom of the transmitter unit, the receiver circuit induces no signal from the at least one transmitter circuit of the transmitter unit. When the receiver unit is detached from the transmitter unit and disposed within the induction range of one transmitter circuit of the transmitter unit, the receiver circuit generates electricity by induction, and the induced electricity is transmitted via transmission port.

Preferably, the transmission port is Universal Serial Bus (USB) port or a Thunderbolt port, facilitating compatibility with various electronic devices.

Preferably, the transmitter unit and the receiver unit are detachably connectable together by a lug and notch matching structure to facilitate users carrying the wireless charging device.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view illustrating the use of a wireless charging device in accordance with a first embodiment of the present invention in charging an electronic device with wireless charging function.

FIG. 2 is an exploded view illustrating the use of the wireless charging device in accordance with the first embodiment of the present invention in charging an electronic device without wireless charging function.

FIG. 3 is an oblique top elevational view of the wireless charging device in accordance with the first embodiment of the present invention.

FIG. 4 is a circuit block diagram of a transmitter circuit and a receiver circuit.

FIG. 5 is an exploded view illustrating the use of a wireless charging device in accordance with a second embodiment of the present invention in charging two electronic devices with wireless charging function at the same time.

FIG. 6 is an exploded view illustrating the use of a wireless charging device in accordance with the second embodiment of the present invention in charging an electronic device with wireless charging function and an electronic device without wireless charging function at the same time.

### DETAILED DESCRIPTION OF THE INVENTION

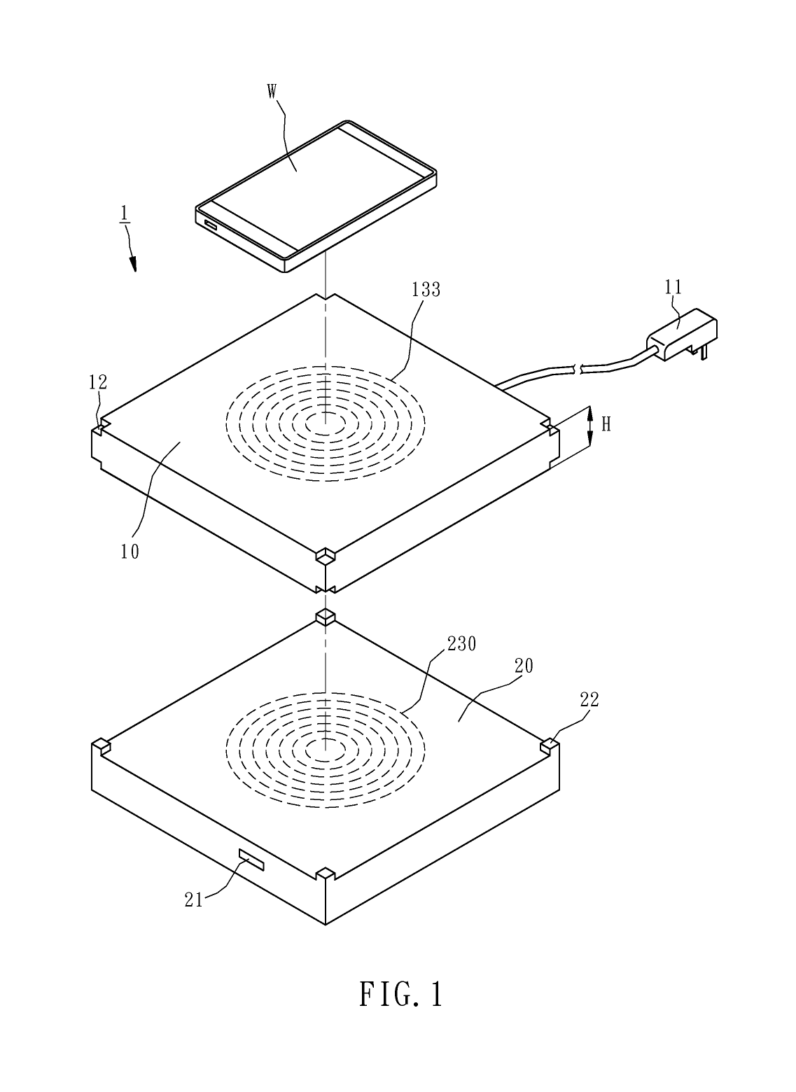

Referring to FIGS. 1-4, a wireless charging device 1 capable of charging a cell phone W with wireless charging function and a cell phone N without wireless charging function in accordance with a first embodiment of the present invention is shown. The wireless charging device 1 comprises a transmitter unit 10 and a receiver unit 20. The relationship between the component parts is described hereinafter:

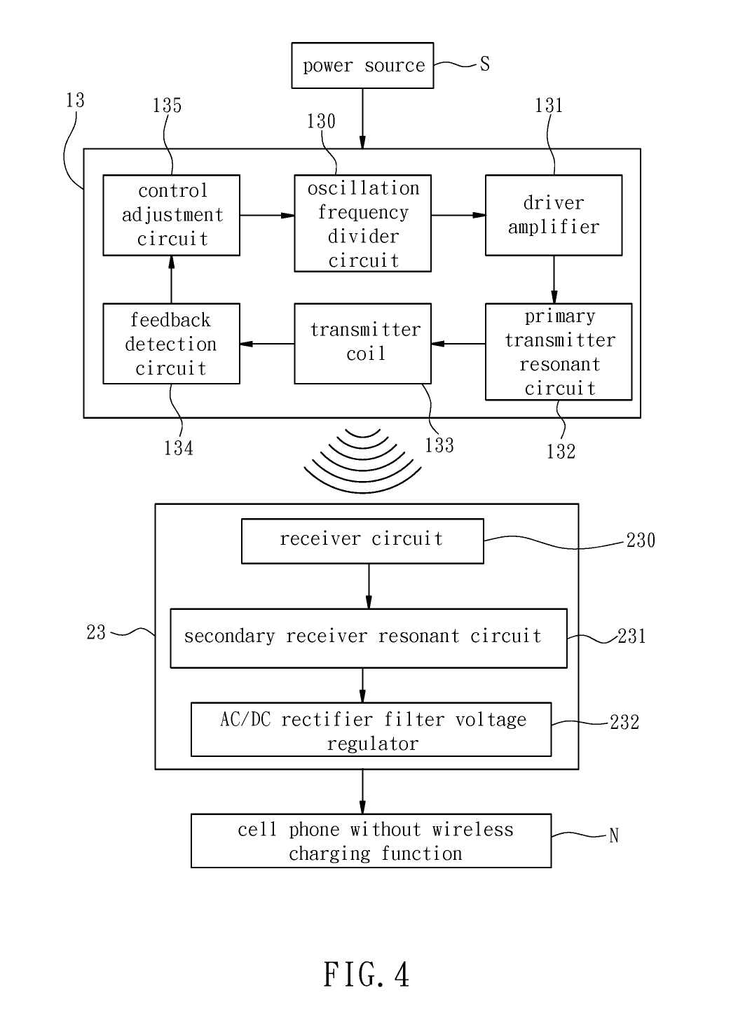

The transmitter unit 10 is a top-flattened rectangular plate member, defining a notch 12 in each four corners of opposing top and bottom sides. The transmitter unit 10 comprises a plug 11, and a transmitter circuit 13 containing a transmitter coil 133 therein (see FIG. 4). The plug 11 is connected to mains power for providing electricity to the transmitter circuit 13. The transmitter circuit 13 is mounted inside the transmitter unit 10, containing a transmitter coil 133 therein.

The receiver unit 20 is also a top-flattened rectangular plate member, comprising a lug 22 at each of four corners of the top thereof, a standard USB type A female connector 21 at one lateral side thereof, and a receiver circuit 23 mounted therein which contains a receiver coil 230 (see FIG. 4). The receiver circuit 23 is electrically connected to the female connector 21, having the receiver coil 230 thereof disposed on the top of the receiver unit 20. The lugs 22 can match the notches 12, enabling the receiver unit 20 to be vertically downwardly or vertically upwardly connects the transmitter unit 10, facilitating users in carrying and using the wireless charging device.

If the object to be charged is a cell phone W with wireless charging function, as shown in FIG. 1, users can place the cell phone W on the transmitter coil 133 within its induction range. At this time, the receiver unit 20 can be placed to the bottom of the transmitter unit 10. When the plug 11 is electrically connected, the internal receiver coil of the cell phone W can sense the signal provided by the transmitter circuit 13 to the transmitter coil 133 and generate electricity by induction. Then, the induced electricity is stored in the battery of the cell phone W. In this embodiment, the thickness H of the transmitter unit 10 is thick enough to prohibit the coupling between the receiver coil 230 and the transmitted signal from the transmitter unit 10. Under this situation, the receiver unit 20 does not affect the charging process, and users can remove the receiver unit 20 and use the transmitter unit 10 to charge the cell phone W.

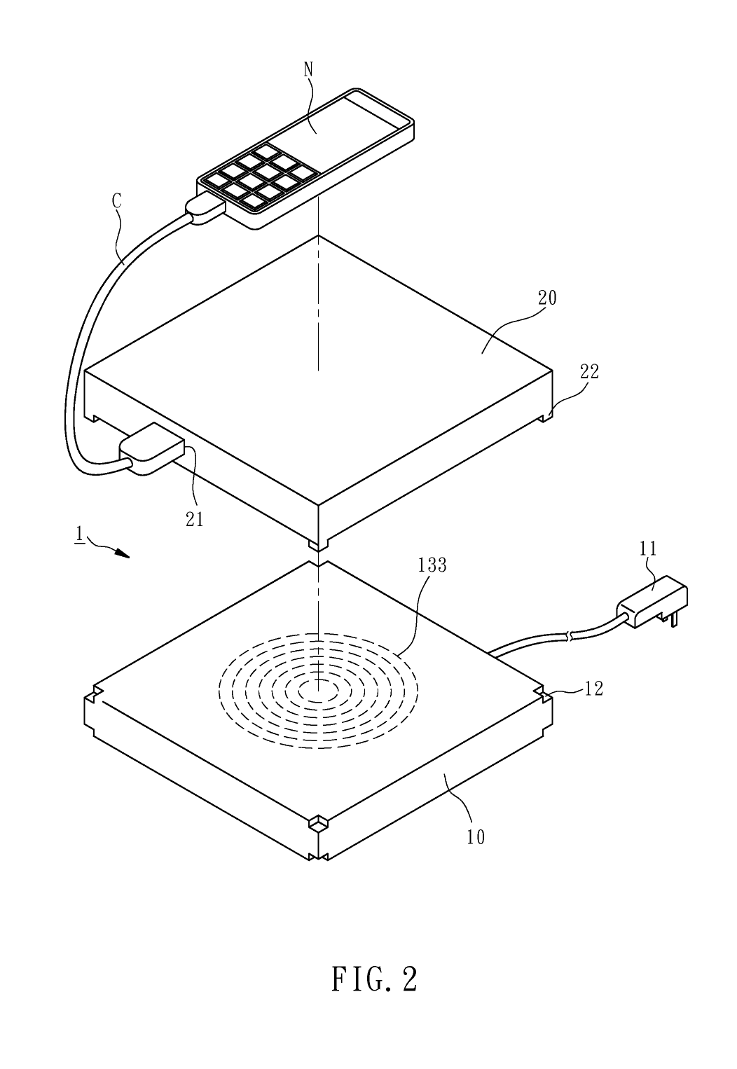

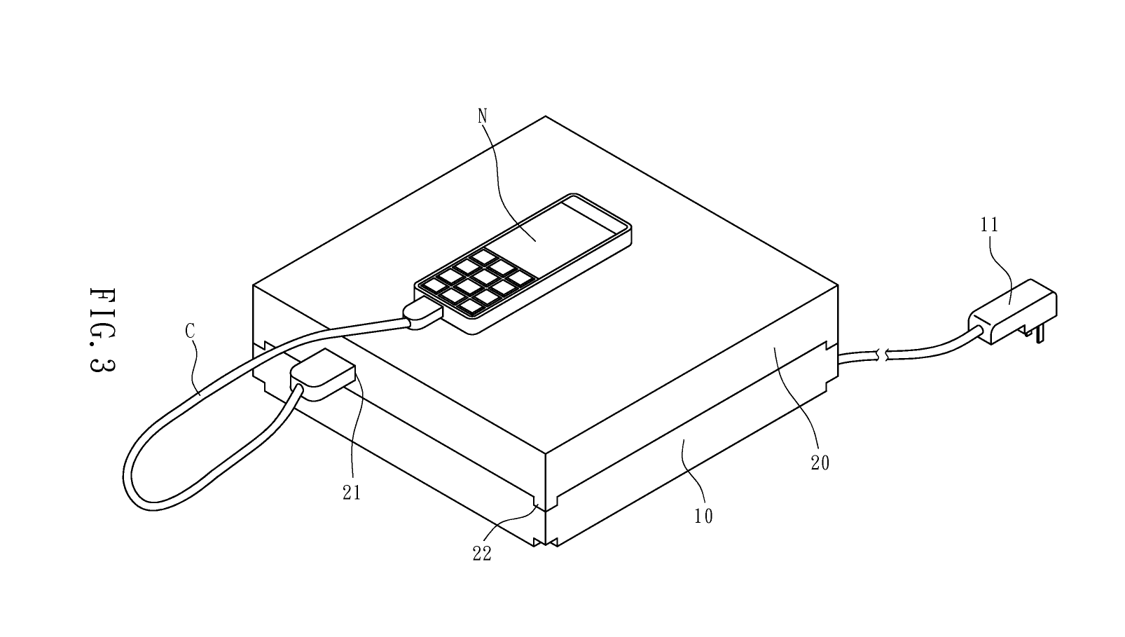

If the object to be charged is a cell phone N without wireless charging function, as shown in FIGS. 2 and 3, users can pick up the receiver unit 20 and connect it vertically downwardly to the top of the transmitter unit 10. When users connect the plug 11 to mains power and use a transmission cable C to electrically connect the cell phone N and the female connector 21, the receiver coil 230 faces down and is aimed at the upward-facing transmitter coil 133. Thus, the receiver coil 230 can sense the signal provided by the transmitter circuit 13 to the transmitter coil 133 and generate electricity by induction. Further, because the receiver coil 230 is kept in proximity to and aimed at the transmitter coil 133, the invention significantly improves the charging efficiency. The induced electricity is transmitted via the transmission cable C to the battery of the cell phone N, enabling the battery to be charged. Thus, the invention is applicable to different electronic devices, either with or without wireless charging function. Further, the transmitter unit 10 and the receiver unit 20 are detachably connected together, facilitating users in carrying and receiving the wireless charging device.

It is to be noted that the transmitter circuit 13 and receiver circuit 23 for wireless charging are of the known techniques. Nowadays, there are wireless charging-related international standards available, such as Qi (inductive power) standard defined by Wireless Power Consortium (WPC), as shown in FIG. 4. The power source S used in the present invention is DC obtained by: connecting the plug 11 to mains power and using a conventional rectifier filter voltage regulator to convert mains power to DC and to send converted DC to the transmitter circuit 13. The transmitter circuit 13 comprises an oscillation frequency divider circuit 130, a driver amplifier 131, a primary transmitter resonant circuit 132, the aforesaid transmitter coil 133, a feedback detection circuit 134 and a control adjustment circuit 135 that are electrically connected in series, wherein the control adjustment circuit 135 sends the signal back to the oscillation frequency divider circuit 130 to form a loop. The oscillation frequency divider circuit 130 converts DC provided by the power source S to AC signal. This AC signal is then amplified by the driver amplifier 131, and then the primary transmitter resonant circuit 132 obtains resonance frequency from the amplified AC signal. The resonance frequency is then transmitted by the transmitter coil 133 to the receiver coil 230, causing the receiver coil 230 to generate AC signal by induction. Further, the feedback detection circuit 134 feeds back the AC signal of the transmitter coil 133 to the control adjustment circuit 135, allowing the control adjustment circuit 135 to adjust the oscillation frequency of the oscillation frequency divider circuit 130 and to further obtain better resonance quality.

The receiver circuit 23 comprises the aforesaid receiver coil 230, a secondary receiver resonant circuit 231, and an AC/DC rectifier filter voltage regulator 232 that are electrically connected in series. The receiver coil 230 generate the AC signal by induction provided by the transmitter circuit 133, enabling the secondary receiver resonant circuit 231 to obtain resonance frequency from the AC signal. The resonance frequency is than rectified and stabilized by the AC/DC rectifier filter voltage regulator 232, forming a DC power supply that is then provided to the cell phone N without wireless charging function. The aforesaid transmitter circuit 13 and receiver circuit 23 are examples for illustration only. Any person skilled in the art can replace the individual circuits in the circuit block diagram by other equivalent circuits.

It is to be noted that the female connector 21, except the configuration of Universal Serial Bus (USB) port, can also be made in the form of a Micro-USB, Thunderbolt or any other transmission port, facilitating compatibility with various electronic devices. Further, any person skilled in the art can increase the number of transmission ports. Another application of the present invention is: at any place where wireless charging service is available, users can simply use the receiver unit 20 to charge any cell phone N without wireless charging function.

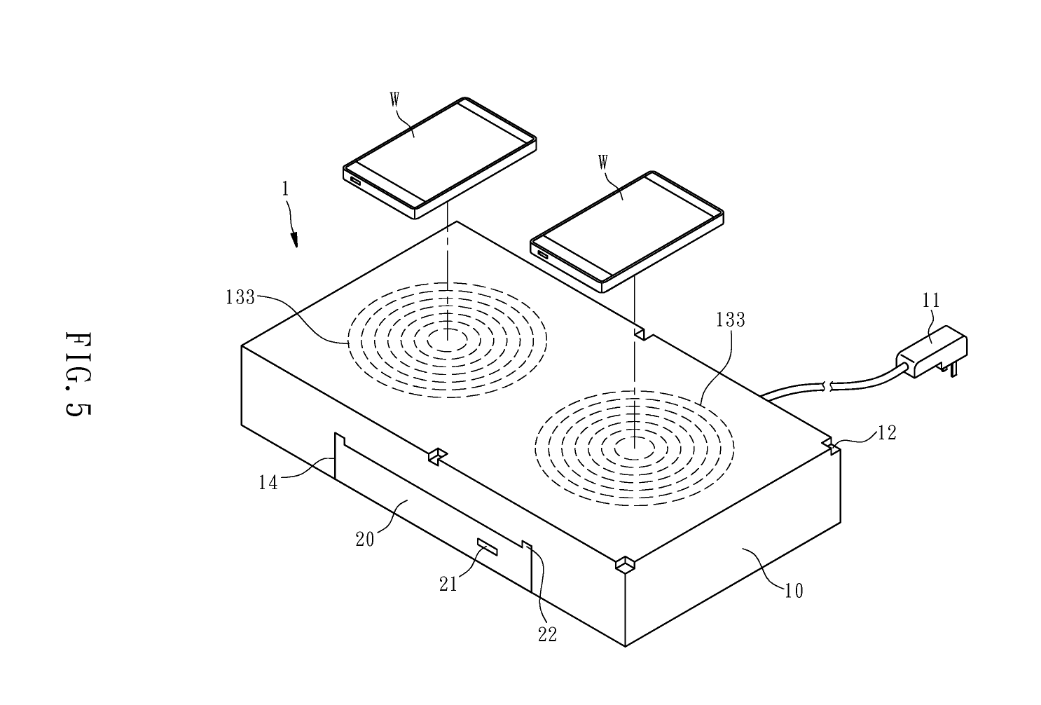

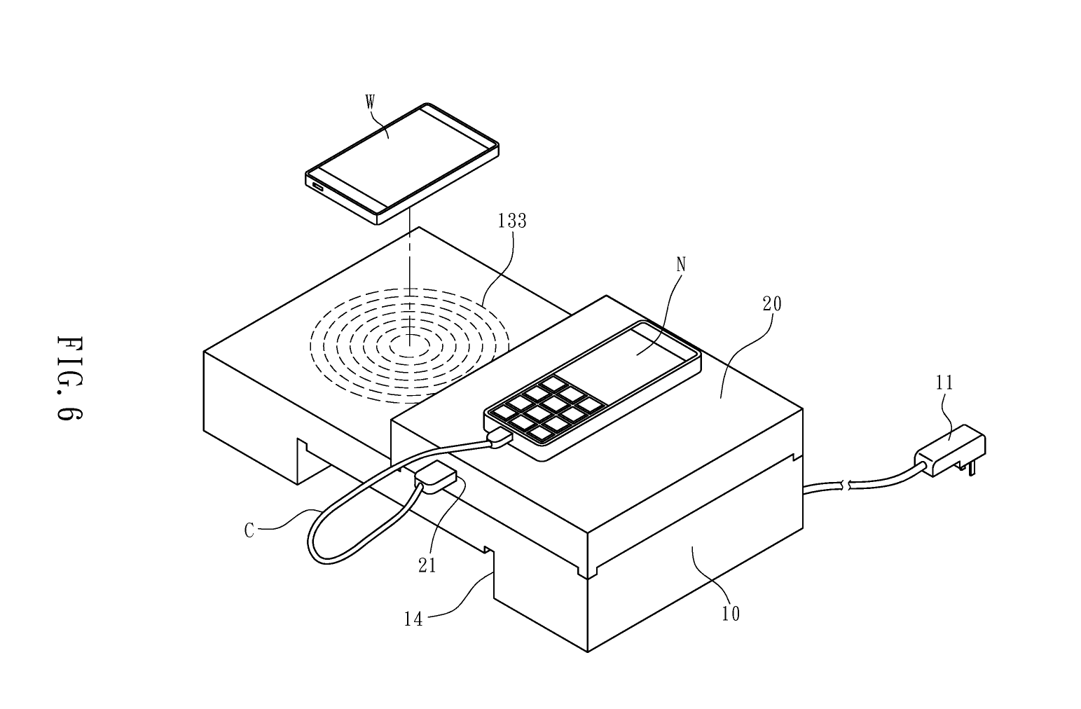

To charge an electronic device with wireless charging function and an electronic device without wireless charging function at the same time, a wireless charging device 1 in accordance with a second embodiment of the present invention is shown in FIGS. 5 and 6. As illustrated, the wireless charging device 1 comprises a transmitter unit 10 and a receiver unit 20. The relationship between the component parts is described hereinafter:

The receiver unit 20 comprises a standard USB3.0 type A female connector 21 at one lateral side thereof, a receiver circuit 20 mounted therein, and a lug 22 at each of four corners of a top surface thereof. The components of the receiver unit 20 and the relationship are the same as that of the aforesaid first embodiment, and therefore no further detailed description in this regard will be given.

The transmitter unit 10 is a top-flattened rectangular plate member, comprising four notches 12 respectively disposed at four corners of a right half of a top thereof. Thus, the receiver unit 20 can be placed on the upper right side of the transmitter unit 10 and connected to the notches 12. A mounting open space 14 is defined in a middle part of a bottom of the transmitter unit 10 and configured to fit the configuration of the receiver unit 20 so that the transmitter unit 10 and the receiver unit 20 can be connected together. Further, the transmitter unit 10 comprises a plug 11, and two transmitter circuits 13. The plug 11 is electrically connected to mains power and the transmitter circuit 13 for providing electricity to the transmitter circuit 13. The transmitter circuits 13 are mounted inside the transmitter unit 10, each comprising a transmitter coil 133 respectively disposed on the top of the transmitter unit 10.

If the objects to be charged are two cell phones W with wireless charging function at the same time. In this case, as shown in FIG. 5, users can place the two cell phones W above the two transmitter coils 133 within their induction range respectively. At this time, the receiver unit 20 can be put to the bottom of the transmitter unit 10. When the plug 11 is electrically connected, the internal receiver coil of each cell phone W senses a signal transmitted by the transmitter coil 133 of the respective transmitter circuit 13 and generates electricity by induction. The generated electricity is stored in the battery of the respective cell phone W. Likewise, in this embodiment, no signal coupling will occur between the receiver coil 20 and the respective transmitted signal when the receiver unit 20 is put to the bottom of the transmitter unit 10. Under this situation, the receiver unit 20 does not affect the charging process, and users can also remove the receiver unit 20 and use the transmitter unit 10 to charge the cell phone W.

If the objects to be charged are one cell phone W with wireless charging function and one cell phone N without wireless charging function, as shown in FIG. 6, users can connect the receiver unit 20 vertically downwardly to the right half of the top side of the transmitter unit 10. When users connects the plug 11 to mains power and uses a transmission cable C to electrically connect the cell phone N and the female connector 21, the receiver coil 230 of the receiver unit 20 faces down and is aimed at the upward-facing transmitter coil 133 of the respective transmitter circuit 13. Thus, the receiver coil 230 can sense the signal which is transmitted from the transmitter circuit 13 to the transmitter coil 133, and generate electricity by induction. The induced electricity will then be transmitted via the transmission cable C to the battery of the cell phone N to charge the battery. At the same time, the cell phone W can be placed on the other transmitter coil 133 within its induction range for charging. Thus, the transmitter unit 10 can provide electricity to both the cell phone N and the cell phone W at the same time.

It is to be noted that in this second embodiment of the present invention, the transmitter unit 10 comprises two transmitter coils 133, and the receiver unit 20 comprises one receiver coil 230. However, any person skilled in the art can increase the number of the transmitter coils 133 and the number of the receiver coil 230 to fit different requirements, for example, increasing the number of the transmitter coils 133 to 3 or more, and the number of the receiver coil 230 to 2 or more. This second embodiment is simply an example but not intended for use as limitations. Further, in the aforesaid first and second embodiments of the present invention, lug and notch matching structure is used to have the transmitter unit 10 and the receiver unit 20 be connected together and keep the receiver coil 230 in proximity to the transmitter coil 133 precisely. Precise positioning of the receiver coil 230 within the induction range of the transmitter coil 133 greatly determines the charging efficiency. Any other positioning measures to connect the transmitter unit 10 and the receiver unit 20, such as optical positioning measures (for example, arranging a light source in the transmitter unit 10 and an optical receiver in the receiver unit 20), positive and negative magnet positioning measure, or screw bolt and screw hole positioning measure can be selectively used as a substitute to connect the transmitter unit 10 and the receiver unit 20.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wireless charging device, comprising:
a transmitter unit comprising at least one transmitter circuit disposed on a top thereof and can be electrically connected to a power source;
a receiver unit detachably mounted to a bottom of said transmitter unit, said receiver unit comprising a receiver circuit; and
at least one transmission port mounted to said receiver unit and electrically connected to said receiver circuit to transmit electricity;
wherein when said receiver unit is mounted to the bottom of said transmitter unit, said receiver circuit induces no signal from said at least one transmitter circuit of said transmitter unit; when said receiver unit is detached from said transmitter unit and disposed within the induction range of said transmitter circuit of said transmitter unit, said receiver circuit generates electricity by induction and transmits the induced electricity via said at least one transmission port.

2. The wireless charging device as claimed in claim 1, wherein said at least one transmission port is universal serial bus (USB) port or Thunderbolt port.

3. The wireless charging device as claimed in claim 1, wherein said transmitter unit further comprises a plug electrically connected to said at least one transmitter circuit for connecting to said power source.

4. The wireless charging device as claimed in claim 1, wherein said transmitter unit and said receiver unit are detachably connectable together by one of lug and notch connection structure, magnetic attraction, light source and optical receiver combination, screw bolt and screw hole connection structure.

5. The wireless charging device as claimed in either of claims 1-4, further comprising a transmission cable electrically connected to said at least one transmission port for transmitting electricity .
